(19) United States
(12) Patent Application Publication
(10) Pub. No.: US 2018/0041870 A1
(43) Pub. Date: Feb. 8, 2018

(54) Detection Using NFC Open Circuit

(71) Applicant: Wymond Choy, Lafayette, CA (US)

(72) Inventor: Wymond Choy, Lafayette, CA (US)

(21) Appl. No.: 15/229,643

(22) Filed: Aug. 5, 2016

(51) Int. Cl. H04W 4/02; H04L 12/46; H04B 5/00; H04W 12/06; H04W 76/02; H04W 4/00

(52) U.S. Cl. CPC H04W 4/025; H04W 76/023; H04W 4/008; H04B 5/0031; H04W 12/06; H04W 4/005; H04L 12/4633

(57) ABSTRACT

The present invention relates to an alternative method of detecting a change in relative location using NFC pairing to indirectly monitor spatial separation between two devices, and in the case of a security system, sensing unauthorized intrusion. The invention provides a method and apparatus for monitoring changes by having the active NFC Reader send out an interrogation message to a Tag on an intermittent basis, for connecting to a controller and/or other NFC devices in the presence of certain events, and setup of the on-premise portion of an alarm system utilizing NFC.

### TECHNICAL FIELD

The present invention relates to the use of NFC devices to detect movement or spatial separation, and more specifically, as sensors in a security or alarm system.

### BACKGROUND OF THE INVENTION

For many years, alarm systems have employed sensors physically connected to a device controlling the system. In such a system, the sensor performs the task of detecting unauthorized activity and signals the device controlling the system to set off sirens and/or send out an alert.

The aforementioned system has served satisfactorily in the past using various means of detecting unauthorized presence.

Magnets—The most common device used is the Contact Sensor. One part houses a magnet or magnetic current, the other a switch that turns on when near the magnet. If the two are separated, the switch flicks off and the circuit breaks.

Heat—Motion detectors or PIR sensors uses infrared light to detect temperature changes in the nearby air. If the change is great enough, the sensor sends the signal.

Sound—Ultrasonic detectors are very similar to PIR sensors, but instead of detecting heat they use sound waves that sense any type of movement. Shock alarms rely on audible sound to detect either the sharp sound of something breaking (e.g. glass) or the vibrations that accompany the event.

Radio—Microware sensors also works based on the principle of radar, but rather than sending out sound waves, it sends out microwave radio waves.

Light—A Photobeam relies on a basic focused light beams or laser. These sensors detect when the beam is broken.

Although the field of alarms and sensors is a very developed one, it has proven to be amenable to upgrades and new functionality, including wireless connectivity to simplify installation, and use of RFID tags to identify specific sensors within the system.

RFID is the method of uniquely identifying items using radio waves. At a minimum, an RFID system comprises a tag, a reader, and an antenna. The reader sends an interrogating signal to the tag via the antenna, and the tag responds with its unique information.

RFID tags are either Active or Passive. Active RFID tags contain their own power source and have a read range of up to 100 meters. Passive RFID tags do not have their own power source. Instead, they are powered by the electromagnetic energy transmitted from the RFID reader. Passive RFID tags have a read range up to 25 meters.

Near Field Communications (NFC) is an RFID implementation designed for communication at very close range. No pairing code is necessary to link up. Once one NFC device is activated by another, small amounts of data between the two devices can be transferred when placed within a few centimeters of each other. NFC devices can read tags and act as both a reader and a tag like traditional RFID devices. In addition, NFC does what traditional RFID can't, which is peer-to-peer communications. Once the information is exchanged, the process is complete.

Examples of NFC applications used and envisioned include paying bills, starting a car or unlocking its door, facilitating the pairing of Bluetooth devices, turning on various functions inside a car, sharing wi-fi without sharing password, and other uses effected as soon as the tag and reader are paired.

Given the need for continued improvements and the desire to enhance functionality, usability and ease of implementation, what is needed is a method using NFC devices to detect movement, a system and design for a sensor based on a pair of NFC devices, and a method to integrate them into an alarm system using NFC peer-to-peer communications.

### BRIEF SUMMARY OF THE INVENTION

The first aspect of the present invention is to provide an apparatus comprised of a pair of devices containing NFC chips. One of the devices may be a passive Tag; the other an active Reader. The active Reader may be powered by an external (e.g. AC) or internal (e.g. battery) source.

The data format used by the Tag and the Reader may comply with NDEF, a standardized data format structures to exchange information between compatible NFC devices, or it may use any other record data format that can be read by the devices, such as ISODEF.

One physical factor influencing whether or not two NFC devices will or will not interact with each other is distance between them. An attempt to pair takes place when the Tag is placed close enough to the Reader to be affected by the electromagnetic wave generated by the Reader. When too far removed to be influenced by the Reader, the Tag cannot get power to communicate and pairing is not possible. Taking advantage of NFC and its inherently very limited range, any spatial movement of one device relative to the other even just a few centimeters, will affect the ability to pair the Passive Tag with the Active Reader. Such may be the case when a box, door or window is opened, for example.

The second aspect of the present invention is to provide a method to monitor an event, such as an unauthorized intrusion. For the NFC devices to pair, the Reader sends an interrogating signal to solicit a response from the Tag. When in range, the Tag responds with its tag ID and other data needed to pair and the pairing event is recognized by the Reader. Each time an interrogating signal is sent, the Tag will keep responding as long as it can be influenced by the electromagnetic wave generated by the Reader.

To monitor movement or a change in spatial separation, what is required is a method to query the Tag regularly. One design specifies that the Reader send interrogatory signals to influence the Tag at regular intervals. The Reader monitors when there is change in the Tag's ability to affect a pairing response. Another design may be based on powering on and off the electromagnetic wave at regular intervals. A potential intrusion is indicated when there is no response from the passive device when interrogated.

In our design, in addition to logic to recognize paired and unpaired states, there may be a third state called standby. When used as a sensor, standby pauses the switch from sending interrogatory signals until it receives activation instructions. When not on standby, the NFC switch is set to ignore all instances of pairing and act only when the Reader is unable to solicit a response from the Tag or cannot pair.

The third aspect of the present invention is to provide a method for the NFC devices when used as an alarm sensor to signal the device controlling the system (the Controller). The component of the sensor performing this task is the Reader. For this purpose, the NFC chip contained in it cannot be used due to its limited range. The Reader must rely on another wired or wireless technology capable of transmitting over longer distances. This capability may be integrated into the Reader or linked in other fashions. For example, the signal may be transmitted over a wi-fi network when an intrusion is detected by the sensor. This aspect of the present invention related to the NFC sensor may utilize any suitable means of data transmission and does not place any limit on how the signal is transmitted.

The fourth aspect of the present invention is to provide a method to map NFC sensor(s) when used in on-premise systems such as an alarm system without the need for supplemental tagging. RFID standards define the presence of a unique tag ID for each NFC device. With the unique tag ID already built in each Reader (and Reader/Tag combination) may be mapped into a database contained in a Controller or other management component of the alarm system (such as the server or the phone). The tag ID data may be used by the Controller to manage sensor(s) individually, according to instructions. By incorporating the tag ID into the signal for an alarm system, the identity and location of the Reader is known to the system and consequently the point of the intrusion.

The fifth aspect of the present invention is to provide a method for an NFC sensor, using the Reader, to send instructions to other devices installed in the premise. The interrogatory signal emitted by the NFC reader is agnostic and any NFC devices within range can respond. In addition, range can be affected by power output in the form of varying strengths of the electromagnetic wave. In case more than one NFC device is installed in the proximity of the Reader, by increasing the signal strength of the Reader, a connection can be established with another NFC device within interrogating distance. This invention contemplated such a cluster may exist in the vicinity of a sensor. The Reader component of the Sensor may increase or vary the strength of its electromagnetic wave when in a certain state (e.g. an intrusion is detected), to effect pairing with another NFC device. Such NFC devices may be connected to a phone line, a video camera, a mobile phone, or a physical switch, etc.

A sixth aspect of the present invention is to provide a method to set up, configure and integrate all the devices in the on-premise system using the Smartphone. For privacy and security, the present design for an on-premise system contemplates the use of system key. System key information is exchanged upon NFC pairing with the Smartphone to allow sensors and other devices to be added to the on-premise system and for changes to be made. The peer-to-peer mode of NFC may initiate automatic setup processes as soon as the Smartphone is placed next to the device being configured and added. The use of NFC pairing affords the benefits of ease of use and an extra level of security to the on-premise system setup process.

A seventh aspect of the present invention is to provide a method to manage the NFC sensors in the on-premise system using a mobile APP installed in the Smartphone in combination with the sixth aspect of the present invention described above. This design entails the user setting up a personal ID for the system known as an app ID. The app ID interfaces with the NFC sensors and other NFC devices directly or through the Controller using the app ID for authentication and the tag ID for identification and location of the sensor(s) or device. Using this design, the user may manage the state of the sensors, each sensor individually, or other NFC devices linked to it, in real time.

For a better understanding of the present invention, together with other and further aspects thereof, reference is made to the following description, taking in conjunction with the accompanying drawings, and its scope pointed out in the claims.

### BRIEF DESCRIPTION OF THE DRAWINGS

FIG. 1 is a block diagram of an alarm system in accordance with one embodiment of the invention.

FIG. 2-1 is a block diagram of the data transferred during setup, including the data transfer method, in accordance with the embodiment of the invention.

FIG. 2-2 is a block diagram of the data transferred during setup of the sensors, including the data transfer method, in accordance with the embodiment of the invention.

FIG. 3 is a block diagram of an alarm system that includes a cluster of NFC devices around the Reader, in accordance with another embodiment of the invention.

### DETAILED DESCRIPTION OF THE EXEMPLARY EMBODIMENTS

The present invention will now be described in detail with reference to the drawing. In the drawings, each element with a reference number is similar to other elements with the same reference number.

It should also be appreciated that many of the elements discussed in this specification may be implemented as a finished piece of hardware(s), a hardware circuit(s), a processor executing software code, or a combination of a hardware circuit(s) and a processor or control block of an integrated circuit executing machine readable code. As such, the term device, chip, system, module, server, or other equivalent description of an element as used throughout the specification is intended to encompass hardware, a hardware circuit (whether discreet elements or an integrated circuit block), a processor or control block executing code, or a combination of a hardware circuit(s) and a processor and/or control block executing code

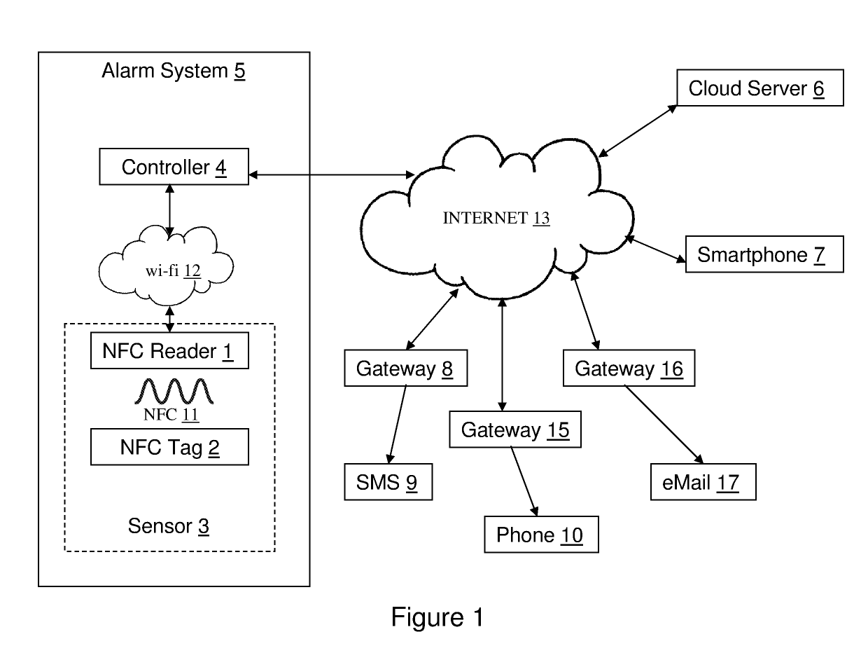

Referring now to FIG. 1, the Internet 13 interconnects the controller 4 in the on-premise portion of an alarm system 5 with a cloud server 6 and other devices in the cloud. These other devices coupled to the Internet 13 may be gateway 15 to the public switched telephone network, gateway 8 to a short message service, gateway 16 to the email server, or other such gateways.

For providing Internet connection, the network protocol may support the Internet Protocol (IP) suite such that the cloud server 6 may communicate with other IP compliant devices coupled to the Internet. All devices coupled directly to the Internet 13 are capable of two-way communication.

When the sensor 3 detects an intrusion, a message is sent to the controller 4 over a local area network, such as wi-fi 12. The controller 4 takes the signal it has received from the sensor and forwards a message to cloud server 6 over the Internet 13. Based on user defined rules, cloud server 6 sends an alert directly to the smartphone 7 over the Internet 13, or connects via the Internet 13 to a designated gateway 8, gateway 15 and/or gateway 16 based on user preference for method of notification, SMS 9 for a text message, phone 10 for a phone call, or email 17.

An on-premise alarm system 5 is minimally made up of one or more sensor(s) 3 and a controller 4.

In the exemplary embodiment, the sensor 3 designed to detect unauthorized presence is a pair of NFC devices made up of a NFC reader 1 and a NFC tag 2. NFC reader 1 is an active device having either internal (battery) or external (AC) power, while NFC tag 2 relies on the electromagnetic wave NFC 11 generated by the NFC reader 1 for its power.

NFC reader 1 is designed to be stationary and mounted to an immovable part of a structure, for example on the frame of the door. Placement requirement for NFC tag 2 is that it be mounted next to and very close (a distance by design that is less than 10 cm) to NFC reader 1. NFC tag 2 is mounted on a moveable part, such as the door itself.

Using NFC and its inherently very limited range, a connection which pairs a passive NFC tag with an active NFC reader is lost or broken whenever the paired devices are moved short distances away from each other, which will be the case when the door is opened, for example. The changing of state from paired to not-paired in our design represents an open or close circuit in the switch on the sensor 3.

For the sensor 3 to detect a change in state, the NFC reader 1 monitors when the NFC devices needing to be paired are out of range of each other by constantly interrogating and requesting a response from the NFC tag 2. When interrogated, NFC tag 2 responds with tag data as long as its location has not changed. A potential break is indicated when there is no response from the NFC tag 2 when interrogated.

Communication between the NFC reader 1 and the controller 4 requires a separate protocol other than NFC. Such a protocol may be a local area network using wi-fi. This capability may be integrated into the NFC reader 1, or connected externally.

When the NFC tag 2 is interrogated, it will send information to the NFC reader 1 to authenticate itself. At the minimum, each NFC reader 1 and NFC tag 2 will have a unique tag ID. In addition, each sensor 3 component may have a common identifier (e.g. pair ID) which prevents other devices from spoofing the tag ID. Alternatively, a more secure data format may be employed by itself or in combination with the pair ID.

During setup, the tag ID of the NFC reader 1 is provided to and stored by controller 4. By incorporating the tag ID into the signal, the identity of the NFC reader 1 is known to the system and consequently the point of the intrusion, when mapped to a location. When a message from the sensor 3 is received, controller 4 will use the tag ID to authenticate that the alarm is coming from a sensor managed by it.

During setup, the pair ID of the sensor, which may be hardcoded into the components of the sensor 3, may also be sent by the NFC reader 1 to controller 4. By providing the pair ID, the identity of NFC reader 1 may be cross-referenced to its tag ID. When a message from the sensor 3 is received, controller 4 can use the more secure pair ID to authenticate that the alarm is coming from a sensor 3 managed by it, in this instance.

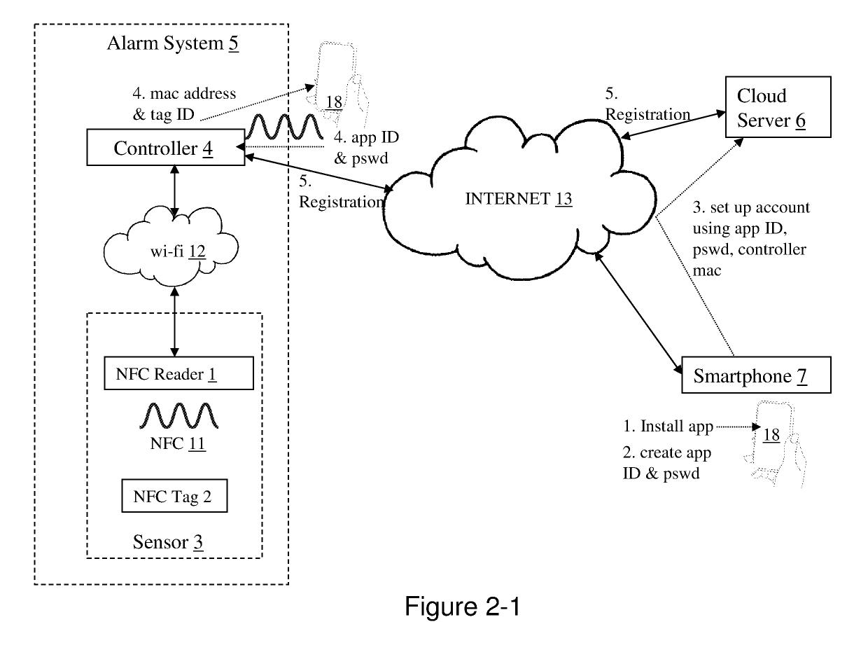

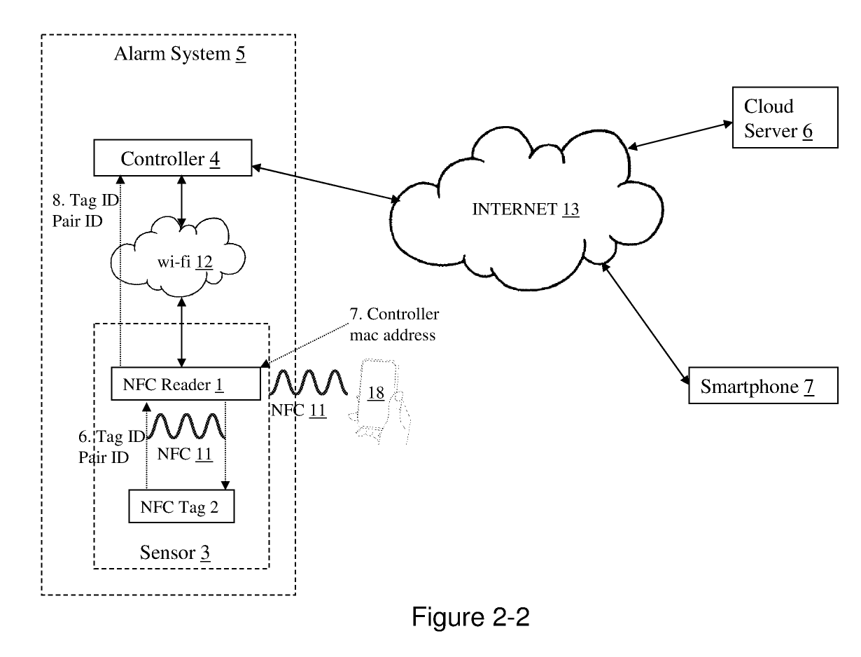

The smartphone 7 is equipped with NFC, wi-fi and IP capabilities. A mobile APP makes use of the smartphone 7 for system setup and management. Referring to FIG. 2-1, the initial steps to set up the system remotely are as follows:
1. The NFC capable smartphone 7 loaded with the mobile APP is shown as APP 18.
2. Using APP 18, the user creates his app ID and password.
3. APP 18 connects to the cloud server 6 and sets up an account on the cloud server 6 using the app ID and password, along with the mac address and phone number of smartphone 7.
4. Next the APP 18 is placed against the controller 4. Once paired, the APP 18 invokes the following: the mac address and tag ID of the controller 4 is retrieved by APP 18. Simultaneously, the cloud server 6 address, plus the app ID and password created by the user is retrieved by the controller 4 using NFC peer-to-peer mode.
5. Registration: The controller 4 is now able to connect to the cloud server 6 over Internet 13 for authentication using the app ID and password plus its mac address. A preloaded mac address file may be used to ensure that the controller 4 being linked is authorized to connect. This process links the APP 18, the controller 4, and the account created in cloud server 6.

Referring to FIG. 2-2, the remaining steps to set up the NFC sensor 3 and other local devices are as follows:
6. To link the on-premise sensor(s) 3 to the controller 4, the smartphone 7 is placed against the NFC reader 1 (on each sensor, one at a time). Once paired, the APP 18 invokes the following: The NFC reader 1 is switched out of standby mode and begins sending its interrogatory signal for the NFC tag 2 to respond to. The response will include the tag ID of NFC tag 2. A pair ID may also be used for pairing confirmation. The tag ID(s) of the NFC tag 2 and the NFC reader 1 is associated with this sensor 3.
7. Upon pairing, the sensor 3 is ready to connect to controller 4, using APP 18 in the smartphone 7 to setup the connection. Registration with controller 4 takes place with the APP 18 placed next to the NFC reader 1. In this process the mac address of the controller 4 is provided to it by APP 18 for connecting to the controller 4 over the LAN.
8. Once connected to controller 4, the NFC reader 1 registers itself with controller 4 using its tag ID (and possibly its pair ID).
9. Any other NFC component on the system, as described below, will be setup in the same manner with the APP 18 placed next to it.

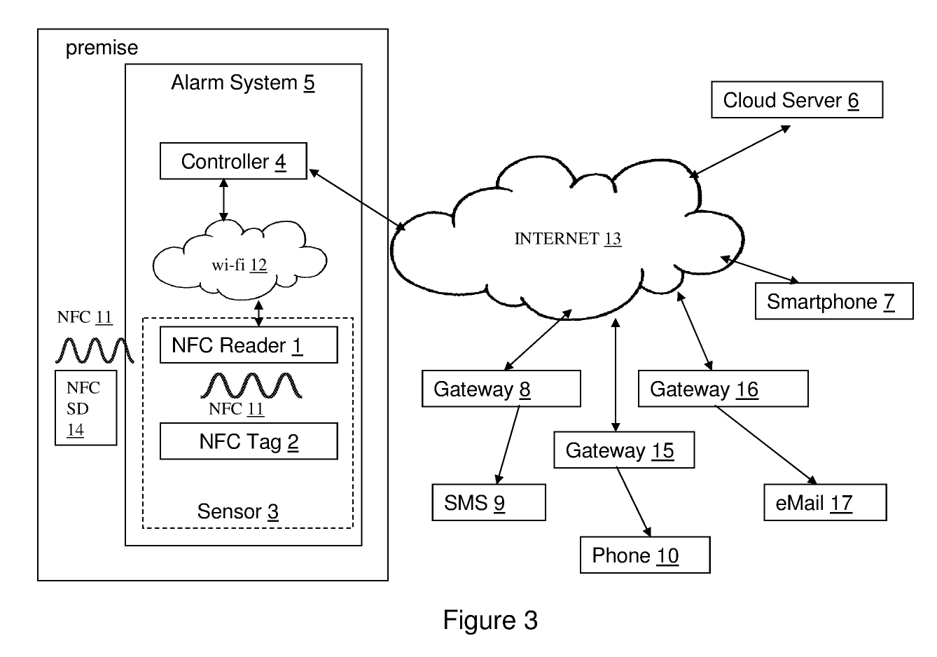

Referring to FIG. 3, an alternative embodiment of the present invention is shown to include other NFC SD (standby device(s)) 14 along with NFC reader 1 and NFC tag 2 that comprise the sensor 3. Each of the NFC SD 14 represents active NFC devices capable of peer-to-peer communication with NFC reader 1. Under specific conditions, e.g. in case power is cut and the NFC reader 1 of the sensor 3 is unable to reach the controller 4, the NFC reader 1 may rely on NFC to cause specified actions to be taken. NFC reader 1 may increase or vary the strength of its electromagnetic wave so as to pair with a NFC SD 14. Once paired, NFC reader 1 may direct NFC SD 14 to take certain action(s), such as sending out messages, sounding a siren, locking doors, activating other security device, etc. NFC SD 14 may have such capabilities integrated into the device or be connected to separate hardware.

NFC communication between devices may use NDEF, any other data exchange format recommended by the NFC Forum, or ISODEP to describe how a set of actions are to be encoded onto a NFC tag or to be exchanged between two active NFC devices.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. An apparatus capable of detecting spatial separation between objects using NFC pairing to define a close or open circuit, comprising:
A pair of devices consisting of an active NFC reader and a passive NFC tag each to be permanently mounted to two independent objects where:
in its normal “close” state, the NFC reader and NFC tag are close enough to each other for pairing to take place;
movement of one of the independent objects with the NFC tag or NFC reader attached prevents pairing and creates an open circuit.

2. The device in claim 1, containing a processing circuit in the NFC reader, designed to:
send intermittent interrogatory signals;
translate a change in the response or lack of response from the NFC tag as a change in the relative position of the object to which the NFC tag and NFC reader are attached, whereby:
A change from paired to unpaired is an event defined as the reader and tag being separated;
A change from unpaired to paired is an event defined as the reader and tag being brought closer together.

3. The device of claim 2 comprising other circuits in the NFC reader capable of generating signaling messages, based on detected spatial separation changes.

4. The device circuit of claim 2, wherein the failure to detect a response further comprises:
a processing circuit capable of communicating with a system controller, mobile phone or other device; and
a processing circuit capable of controlling the power of the electromagnetic wave emitted by the NFC chip.

5. The device circuit of claim 2, wherein the NFC Reader has a means of translating encapsulated data received from the NFC Tag for purposes of authentication.

6. The device circuit of claim 5, wherein the failure to authenticate the identity of the interrogated device further comprises a processing circuit capable of:
a processing circuit capable of communicating with a system controller, mobile phone or other device; and
a processing circuit capable of controlling the power of the electromagnetic wave emitted by the NFC chip.

7. A method of using the device in claim 2 to sense unauthorized intrusion, wherein the steps of sending out instructions further comprises translating the condition into an alert in an alarm system.

8. A method of integrating the apparatus in claim 2 into an alarm system, consisting of the apparatus in claim 2:
Integrated with a smartphone;
integrated with a controller;
integrated with a controller and cloud server; or
integrated with a controller, cloud server and smartphone.

9. A method of using an integrated communications device (NFC capable Smartphone) to connect the apparatus in claim 2 to a Controller wherein the communications and information exchange takes place using NFC peer-to-peer and is accomplished by touching the Smartphone to the Controller and then to the apparatus(es) in claim 2, in that specific order.

10. A method of using an integrated communications device to map the apparatus in claim 2 to specific locations on a premise by associating each reader to its tag ID and/or a PairID.

11. A method of using an integrated communications device (NFC capable Smartphone) to communicate and manage each component of a system that incorporates the apparatus in claim 2.

12. The device of claim 3 comprising other circuits in the NFC reader capable of transmission over another network.
